(19) United States
(12) Patent Application Publication
(10) Pub. No.: US 2026/0351592 A1
(43) Pub. Date: Nov. 5, 2026

(54) PROCESS FOR PRODUCING LITHIUM-CONTAINING MIXED METAL OXIDE MATERIAL

(71) Applicant: Albemarle Corporation, Charlotte, NC (US)

(72) Inventors: Mohammad Norouzi BANIS, Lawrenceville, GA (US); Yinzhi ZHANG, Charlotte, NC (US); Singyuk HOU, Belmont, NC (US); Jingnan LI, Kings Mountain, NC (US); Liu LUO, San Jose, CA (US); Job T. RIJSSENBEEK, Lake Wylie, SC (US)

(73) Assignee: Albemarle Corporation, Charlotte, NC (US)

(21) Appl. No.: 19/487,305

(22) PCT Filed: May 23, 2024
(86) PCT No.: PCT/US2024/030733

§ 371 Date: Nov. 24, 2025

Related U.S. Application Data
(60) Provisional application No. 63/469,998, filed on May 31, 2023.

(51) Int. Cl. H01M 4/525; C01G 53/502; H01M 4/02

(52) U.S. Cl. CPC H01M 4/525; C01G 53/502; C01P 2002/01; C01P 2002/72; C01P 2006/40; C01P 2006/90; H01M 2004/021

(57) ABSTRACT

Calcining a mixed metal oxide composition to form a cathode material. The mixed metal oxide composition is one formed by mixing (i) a metal-containing precursor and (ii) a lithium precursor comprising lithium peroxide (Li₂O₂), lithium hydroperoxide (LiOOH), lithium peroxide monoperoxohydrate trihydrate (Li₂O₂·H₂O₂·3H₂O) or a mixture of any two or more of the foregoing. The cathode material formed comprises a compound having the formula (II): qLi₂MnO₃·(1−q)LiNiₐMn_{b}Co_{c}M_{y}O_{2+z} (II) wherein 0≤q≤0.8, c=1−a−b, 0≤a≤1, 0≤y≤0.05, −0.025≤z≤0.125, and M is selected from the group consisting of Al, Mg, Ti, Mo, Nb, Zr. Hf, Ta, W, B, P, F and a combination of any two or more of the foregoing.

### CROSS-REFERENCE TO RELATED APPLICATIONS

This application claims benefit of U.S. Provisional Patent Application Ser. No. 63/469,998, filed May 31, 2023, which is herein incorporated by reference in its entirety.

### FIELD

The present disclosure relates generally to processes to produce lithium-containing mixed metal oxides, including those oxides useful in producing cathodes for secondary Li-ion batteries.

### BRIEF DESCRIPTION

Lithium containing mixed metal oxides find vast utility in cathode materials for the fabrication of cathodes useful for secondary Li-ion batteries. These cathode materials heretofore have been formed by combining a lithium-containing precursor with a mixed transition metal-containing precursor (e.g., a nickel manganese cobalt oxide), to form a mixture that is then placed under conditions so as to form the lithium mixed metal oxide comprising Ni³⁺ (for example, lithium nickel manganese cobalt oxide, often abbreviated “NMC”) for use in cathode formation. The lithium precursors often employed for these purposes are lithium hydroxide or lithium carbonate, and the formation takes place typically under a flow of oxygen to control the chemical reaction environment. As an example, high performance cathode material such as NMC 811 (LiNi_{0.8}Mn_{0.1}Co_{0.1}O₂) can be synthesized in an oxygen-rich atmosphere using lithium hydroxide (LiOH or LiOH·H₂O) as the lithium source, supplemented with a process to remove the generated byproducts such as water or carbon dioxide, depending upon the selected lithium source. As another example, lithium-, manganese-rich cathode material qLi₂MnO₃·(1−q)LiMO₂ such as, e.g., 0.5(Li₂MnO₃)·0.5(LiNi_{0.5}Mn_{0.5}O₂) (also expressed when normalized to O₂ as Li_{1.2}Ni_{0.2}Mn_{0.6}O₂), can be similarly synthesized in an oxygen-rich atmosphere using lithium hydroxide (LiOH or LiOH·H₂O) as the lithium source, supplemented with a process to remove the generated byproducts such as water or carbon dioxide, depending upon the selected lithium source. However, these processes require an enriched flow of oxygen to be supplied to carry out the process and can therefore be costly and more complex to carry out on commercial scales. Thus, there is an ongoing need to develop new processes to produce lithium-containing cathode material more efficiently and more economically.

In general, the present disclosure provides calcined mixed metal oxide composition to form a cathode material, which comprises a compound having the formula (II):

qLi₂MnO₃·(1−q)LiNiₐMn_{b}Co_{c}M_{y}O_{2+z} (II)

wherein 0≤q≤0.8, c=1−a−b, 0≤a≤1, 0<b≤1, 0≤y≤0.05, −0.025≤z≤0.125, and M is selected from the group consisting of Al, Mg, Ti, Mo, Nb, Zr, Hf, Ta, W, B, P, F and a combination of any two or more of the foregoing.

In general, the present disclosure also provides a process that comprises calcining a mixed metal oxide composition to form a cathode material, wherein:
the mixed metal oxide compound is one formed by mixing (i) a transition metal-containing precursor and (ii) a lithium precursor comprising lithium peroxide (Li₂O₂), lithium hydroperoxide (LiOOH), lithium peroxide monoperoxohydrate trihydrate (Li₂O₂·H₂O₂·3H₂O) or a mixture of any two or more of the foregoing; the metal-containing precursor comprises a compound or a mixture of compounds each having the formula (I) or an oxide counterpart thereof:

qMn(OH)₂·(1−q)NiₐMn_{b}Co_{c}M_{y}X₁₊ₖ (I)
wherein 0≤q≤0.8, c=1−a−b, 0≤a≤1, 0<b≤1, 0≤y≤0.05 and M includes one or more selected from the group consisting of Al, Mg, Ti, Mo, Nb, Zr, Hf, Ta, W, B, P and F; wherein X is selected from the group consisting of OH⁻, CO₃²⁻, NO₃⁻, SO₄²⁻, C₂O₄²⁻, C₂H₃O₂⁻, CHO₂⁻, stearate, oleate, tartrate and lactate, and when X is selected from the group consisting of OH⁻, C₃H₃O₂⁻, NO₃⁻, CHO₂⁻, stearate, oleate and lactate, −0.025≤k≤0.25, but when X is otherwise, 0.975≤k≤1.25; and
the cathode material so formed comprises a compound having the formula (II);

qLi₂MnO₃·(1−q)LiNiₐMn_{b}Co_{c}M_{y}O_{2+z} (II)
wherein 0≤q≤0.8, c=1−a−b, 0≤a≤1, 0<b≤1, 0≤y≤0.05, −0.025≤z≤0.125, and M is selected from the group consisting of Al, Mg, Ti, Mo, Nb, Zr, Hf, Ta, W, B, P, F and a combination of any two or more of the foregoing.

Interestingly, it has been found that oxygen (O₂) generated in situ during synthesis of cathode material from the lithium precursor facilitates the reaction, in contrast to the typical byproduct, water, generated during synthesis of cathode material from LiOH·H₂O or LiOH, which needs to be removed from the system as quickly as possible. This feature reduces the need for the oxygen supply to the reactor and overcomes the diffusion limit of oxygen in the precursor mixtures during reaction, so as to enable the use of much simpler reactor configurations and shorter time for the synthesis of cathode materials when the lithium precursor (as defined herein) is used. In addition, the lithium precursor, in at least some aspects of the disclosure enables the synthesis of, for example, single crystalline NMC materials with favorable particle size and performance. For example, NMC 811 prepared according to the disclosure has improved particle size and performance as compared to single crystalline NMC 811 synthesized using the same process with LiOH·H₂O or LiOH as the lithium source. Using the lithium precursor of this disclosure also allows cathode material synthesis at elevated temperature as compared to that using LiOH·H₂O or LiOH. There is a possibility in some aspects of the disclosure of faster reaction and reduced conversion time under elevated temperatures when using the lithium precursor of this disclosure rather than LiOH·H₂O or LiOH, due to the high melting temperature of Li₂O compared to LiOH or Li₂CO₃. In at least some aspects of the disclosure, the process also facilitates the production of cathode materials with a continuous reactor, such as rotary kiln or the like, while decreasing or eliminating the use of oxygen supply to the reactor. This cathode material should be suitable for incorporation into, or use as, core-shell and gradient type cathode material as well.

Thus, in one aspect, the process of this disclosure is carried out such that, in the mixing step, the mole of Li is equal to or greater than the total aggregate moles of Ni, Mn and Co. In another aspect, the mixing step is conducted under an atmosphere which contains less than 3% by weight of moisture to form mixed metal oxide composition. In still another aspect, the mixing step is conducted at ambient temperature and pressure conditions.

In another aspect of the disclosure, the calcinating step is conducted with an external supply of gas which contains an amount of oxygen in the range of about 0.1 to about 90 percent oxygen by weight. In an alternative aspect of the disclosure, the external supply of gas provides an amount of oxygen so that the molar ratio of oxygen provided from the external supply of gas to mixed metal oxide composition being calcined is no greater than 1:4. In still another aspect, the calcinating step is conducted in an atmosphere with a moisture content of 3% or less by weight. In yet another aspect the calcining step is conducted at a temperature in the range of from 700 °C to 1200 °C; and for a time in the range of from 1 hour to 24 hours.

The process may further comprise pre-oxidizing the metal-containing precursor prior to the mixing step in at least some aspects of the disclosure.

In another aspect of the disclosure, the mixed metal oxide composition in the process is in the form of a particulate having an average particle diameter of less than 100 microns.

In yet another aspect, in the process the cathode material is in the form of a particulate having an average particle diameter of less than 50 microns.

In still another aspect of the disclosure, the mixed metal oxide composition in the process is continuously fed into a reactor and the cathode material is continuously at least partially removed from the reactor. In another aspect, the reactor comprises either a rotary reactor or a roller hearth kiln.

While multiple aspects and embodiments of the disclosure are disclosed herein, still other aspects will become apparent to those skilled in the art from the following detailed description. As will be apparent, certain embodiments, as disclosed herein, are capable of modifications in various aspects apparent to those of skill in the art in the light of this disclosure, all without departing from the spirit and scope of the claims as presented below. Accordingly, the figures and detailed description are to be regarded as illustrative in nature and not restrictive.

### BRIEF DESCRIPTION OF THE DRAWINGS

For a detailed description of certain embodiments of the disclosed subject matter, reference will now be made to the accompanying drawing(s) in which:

FIG. 1-1a is an overall scanning electron microscopy (SEM) image of the final NMC 811 synthesized with Li₂O as the lithium source in O₂ flow of comparative Example 1.

FIG. 1-1b is an enlarged SEM image of the final NMC 811 synthesized with Li₂O as the lithium source in O₂ flow of comparative example 1.

FIG. 1-2 is the x-ray powder diffraction (XRD) characterization of the final product of comparative example 1.

FIG. 2-1 is a cross-section SEM image of the NMC 811 synthesized with LiOH·H₂O in the O₂ flow of comparative example 2.

FIG. 2-2 the XRD characterization of the final product of comparative example 2.

FIG. 3-1a is an overall SEM image of the NMC 811 synthesized with Li₂O₂ in the O₂ flow of example 1.

FIG. 3-1b is an enlarged SEM image of the NMC 811 synthesized with Li₂O₂ in the O₂ flow of example 1.

FIG. 3-2 is the XRD characterization of the final product of example 1.

FIG. 4-1a is an overall SEM image of the NMC 811 synthesized with Li₂O₂ in the argon flow of example 2.

FIG. 4-1b is an enlarged SEM image of the NMC 811 synthesized with Li₂O₂ in the argon flow of example 2.

FIG. 4-2 is the XRD characterization of the final product of example 2.

FIG. 5 is the XRD characterization of the final product of example 3.

FIGS. 6, 7-1, 8-1, 9-1, 10-1 are the XRD analysis patterns of the products formed in each of examples 4.1-4.5, respectively.

FIGS. 7-2, 8-2, 9-2, 10-2 are the original cross-section SEM images (left) and the binary cross-section SEM images from thresholding of the products of each of example 4.2-4.5, respectively.

FIGS. 11-15 are the charge and discharge curves for the products of each of examples 4.1-4.5, respectively.

FIG. 16 is bar graph of the first cycle capacities during charging and discharging and Coulombic efficiency (CE) for cells made using the product of each of examples 4.1-4.5 compared to that using LiOH·H₂O or LiOH as the lithium precursor.

FIG. 17 is bar graph of the aspect ratio of the primary particles of NMC 811 synthesized from examples 4.2-4.5 compared to that using LiOH·H₂O as the lithium precursor.

While the claimed subject matter is susceptible to various modifications and alternative forms, the figure(s) illustrate specific features or characterizations of embodiments herein described in detail by way of example. It should be understood, however, that the description herein of specific embodiments is not intended to limit the claimed subject matter to the particular forms disclosed, but on the contrary, the intention is to cover all modifications, equivalents, and alternatives falling within the spirit and scope as defined by the appended claims.

### DEFINITIONS

To define more clearly the terms used in this disclosure, the following definitions are provided. Unless otherwise indicated, the following definitions are applicable to this disclosure. Terms that do not appear below have their ordinary and customary meaning understood in the context of this disclosure by a person of ordinary skill in the art relating to the technical field of this disclosure. To the extent that any definition or usage provided by any document incorporated here by reference conflicts with the definition or usage provided herein, the definition or usage provided in this disclosure controls.

In this disclosure, features of the subject matter are described such that, within particular aspects, a combination of different features can be envisioned. For each and every aspect and each and every feature disclosed herein, all combinations that do not detrimentally affect the designs, systems, compositions, processes, or methods described herein are contemplated with or without explicit description of the particular combination. Additionally, unless explicitly recited otherwise, any aspect or feature disclosed herein can be combined to describe inventive designs, systems, compositions, processes, or methods consistent with this disclosure.

In this disclosure, while compositions and/or processes or methods are often described in terms of “comprising” various components or steps, the compositions and methods can also “consist essentially of” or “consist of” the various components or steps, unless stated otherwise. For example, a process consistent with aspects of the disclosed subject matter can comprise; alternatively, can consist essentially of; or alternatively, can consist of; the process steps indicated.

The terms “a,” “an,” and “the” are intended to include plural alternatives, e.g., at least one, one or more, and one or more than one, unless otherwise specified.

The term “average particle diameter” is intended to mean the average diameter of particles in the referenced composition as determined by laser diffraction particle size distribution measurement.

The terms “room temperature” or “ambient temperature” are used herein to describe any temperature from 15 °C to 35 °C wherein no external heat or cooling source is directly applied to the reaction vessel. Accordingly, the terms “room temperature” and “ambient temperature” encompass the individual temperatures and any and all ranges, subranges, and combinations of subranges of temperatures from 15 °C to 35 °C wherein no external heating or cooling source is directly applied to the reaction vessel. The term “atmospheric pressure” is used herein to describe an earth air pressure wherein no external pressure modifying means is utilized. Generally, unless practiced at extreme earth altitudes, “atmospheric pressure” is about 1 atmosphere (alternatively, about 14.7 psi or about 101 kPa).

The term “about” means that amounts, sizes, formulations, parameters, and other quantities and characteristics are not and need not be exact, but may be approximate including being larger or smaller, as desired, reflecting tolerances, conversion factors, rounding off, measurement errors, and the like, and other factors known to those of skill in the art. In general, an amount, size, formulation, parameter or other quantity or characteristic is “about” or “approximate” whether or not expressly stated to be such. The term “about” also encompasses amounts that differ due to different equilibrium conditions for a composition resulting from a particular initial mixture. Whether or not modified by the term “about,” the claims include equivalents to the stated quantities.

When a numerical range of any type is disclosed or claimed herein (e.g., “ranging from . . . ”, “in a range of from . . . ”, “in the range of from . . . ”, “in a range of from”, “in a range of”) the intent is to disclose or claim individually each possible number or ratio that such a range could reasonably encompass, including end points of the range as well as any sub-ranges and combinations of sub-ranges encompassed therein, unless otherwise specified.

Embodiments disclosed herein can provide the materials listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

Although any methods and materials similar or equivalent to those described herein can be used in the practice or testing of the subject matter described herein, the typical methods and materials are herein described.

All publications and patents mentioned herein are incorporated herein by reference for the purpose of describing and disclosing, for example, the constructs and methodologies that are described in the publications, which can be used in connection with the presently described subject matter.

### DETAILED DESCRIPTION

Illustrative aspects of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

### A. The Mixed Metal Oxide Composition and its Formation

As noted earlier, the mixed metal oxide composition employed in processes of this disclosure is formed by mixing a metal-containing precursor and a lithium precursor. The “lithium precursor” as used herein means a precursor that comprises lithium peroxide (Li₂O₂), lithium hydroperoxide (LiOOH), lithium peroxide monoperoxohydrate trihydrate (Li₂O₂·H₂O₂·3H₂O), or a mixture of any two or more of the foregoing. The lithium precursor may also include, in addition to one or more of the foregoing, other lithium salts, such as for example, lithium hydroxide or lithium hydroxide monohydrate or lithium carbonate. The metal-containing precursor that is brought together with the lithium precursor comprising a compound or a mixture of compounds each having the formula (I) or an oxide counterpart thereof:

qMn(OH)₂·(1−q)NiₐMn_{b}Co_{c}M_{y}X₁₊ₖ (I)

wherein 0≤q≤0.8, c=1−a−b, 0≤a≤1, 0<b≤1, 0≤y≤0.05 and M includes one or more selected from the group consisting of Al, Mg, Ti, Mo, Nb, Zr, Hf, Ta, W, B, P and F; wherein X is selected from the group consisting of OH⁻, CO₃²⁻, NO₃⁻, SO₄²⁻, C₂O₄²⁻, C₂H₃O₂⁻, CHO₂⁻, stearate, oleate, tartrate and lactate, and when X is selected from the group consisting of OH⁻, C₂H₃O₂⁻, NO₃⁻, CHO₂⁻, stearate, oleate and lactate, −0.025≤k≤0.25, but when X is otherwise, 0.975≤k≤1.25.

Non-limiting examples of suitable metal-containing precursors include, Ni_{0.82}Mn_{0.06}Co_{0.12}(OH)₂, Ni_{0.88}Co_{0.06}Mn_{0.03}Al_{0.03}(OH)₂, and the like. Non-limiting examples of suitable oxide counterparts of the metal-containing precursor include Ni_{0.82}Mn_{0.06}Co_{0.12}O, Ni_{0.88}Co_{0.06}Mn_{0.03}Al_{0.03}O, and the like.

The proportions of metal-containing precursor and lithium precursor may vary, but in at least one aspect of the disclosure are such that the moles of Li are equal to or exceed the total aggregate moles of Ni, Mn and Co in the mixture. The mixing step is conducted under an atmosphere in which the moisture level is minimized, and preferably is less than 3% by weight. The mixing step can be conducted at various temperatures and pressures, but preferably is carried out at or within typical earth ambient temperature and pressure conditions.

The process may further comprise dehydrating the metal-containing precursor prior to the mixing step in at least some aspects of the disclosure, in order to further minimize the presence of water moisture. The mixed metal oxide composition so formed in at least some aspects of the disclosure is in the form of particulates having an average particle diameter of less than 100 microns, or less than 50 microns.

### B. Calcination of the Mixed Metal Oxide Composition

The calcining step in processes carried out according to the disclosure can be conducted at a variety of temperatures and time periods, and in a variety of atmospheres consistent with the teachings set forth herein. For instance, the calcining step can be conducted at a peak calcining temperature in a range from about 500 °C to about 1200 °C; alternatively, from about 700 °C to about 1100 °C; or alternatively, from about 750 °C to about 1000 °C. In these and other aspects, these temperature ranges also are meant to encompass circumstances where the calcining step is conducted at a series of different temperatures (e.g., an initial calcining temperature, a peak calcining temperature, and/or a gradient of temperatures between initial and peak that change with time), instead of at a single fixed temperature, falling within the respective ranges. For instance, the calcining step can start at an initial calcining temperature, and subsequently, the temperature of the calcining step can be increased to the peak calcining temperature.

The duration of the calcining step is not necessarily limited to any particular period in every aspect of the disclosure. The appropriate calcining time can depend upon, for example, the initial/peak calcining temperature, and the atmosphere under which calcining is conducted, among other variables. Generally, however, the calcining step can be conducted in a time period that can be in a range of about 1 to about 24 hours.

In the calcining step, an external supply of gas flows typically is provided wherein the gas is inert or contains an amount of oxygen in the range of about 0.1 to about 90 percent by weight, or is pure inert gas flowing at a less than optimal rate. Alternatively, the external supply of gas provides an amount of oxygen so that the molar ratio of oxygen provided from the external supply of gas to mixed metal oxide composition being calcined is no greater than 1:4.

In still another aspect, the calcinating step is conducted in an atmosphere with a moisture content of 3% or less by weight.

As will now be understood, the mixed metal oxide composition employed in at least some aspects of the process may be continuously fed into a reactor carrying out the calcination step, and the resulting cathode material product may be continuously at least partially removed from the reactor to form product in a continuous or semi-continuous manner. Suitable calcination reactors may vary but in at least some aspects of the disclosure the calcination reactor employed facilitates continuous or semi-continuous operations such as, for example, a rotary reactor or a roller hearth kiln.

### EXAMPLES

The subject matter having been generally described, the following examples are given as particular embodiments of the subject matter of this disclosure and to demonstrate the practice and advantages thereof. It is understood that the examples are given by way of illustration and are not intended to limit the claims to follow in any manner.

### Comparative Example 1

Solid-State Synthesis and Characterization of LiNi_{0.82}Mn_{0.06}Co_{0.12}O₂ (NMC 811) with Li₂O in an Oxygen Atmosphere

### Synthesis

20 grams of hydroxide precursor Ni_{0.82}Mn_{0.06}Co_{0.12}(OH)₂ (CNGR Advanced Material Co., China) was calcinated for 15 hours in an oxygen atmosphere at 900 °C to convert to the oxide precursor and remove all the water induced by the environment. 5 grams of the oxide precursor was then mixed and grinded with 1.305 grams of Li₂O (Albemarle Corporation) at a 1.30 Li to TM molar ratio using a mortar and pestle for 10 minutes in an argon-filled glovebox. The mixture was heated in a tube furnace under constant oxygen flow (0.2 NI/min) at 900 °C for 10 hours with 10 °C/min ramping and cooling rate.

### Characterization

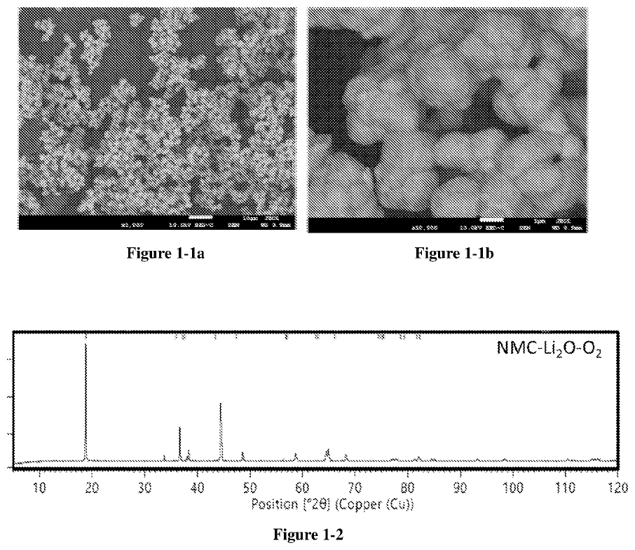

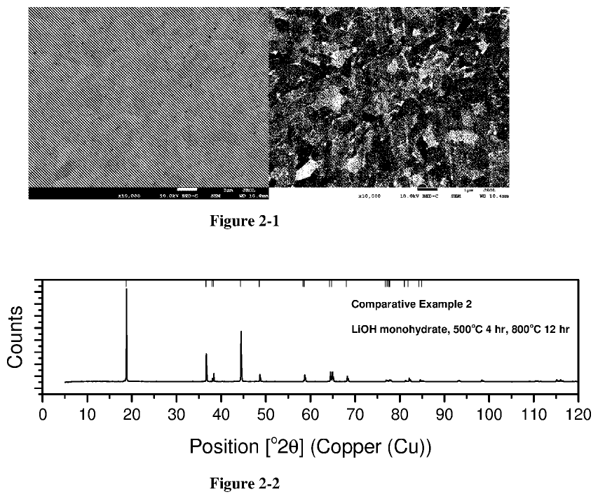

The scanning electron microscopy (SEM) images of the formed NMC 811 (LiNi_{0.82}Mn_{0.06}Co_{0.12}O₂) shown in FIGS. 1-1a and 1-1b demonstrate the aggregates of the structures with primary particle size of around 1-2 μm. The X-ray powder diffraction (XRD) of the formed NMC 811 in FIG. 1-2 confirms the formation of the layered structure.

### Comparative Example 2

Solid-State Synthesis and Characterization of LiNi_{0.82}Mn_{0.06}Co_{0.12}O₂ (NMC 811) with LiOH·H₂O in an Oxygen Atmosphere

### Synthesis

The compounds were synthesized from the transition metal-containing precursor Ni_{0.82}Mn_{0.06}Co_{0.12}(OH)₂ and LiOH. 10 grams Ni_{0.82}Mn_{0.06}Co_{0.12}(OH)₂ and the 4.76 grams LiOH were introduced at 1.05 Li to TM molar ratio into a plastic container for the acoustic mixing at progressively increasing forces of 50 times, 60 times and 70 times gravity, each for 1 min. After mixing, the mixture was transferred to an alumina crucible and placed in a tube furnace under oxygen flow. The Ni_{0.82}Mn_{0.06}Co_{0.12}(OH)₂ and LiOH mixture underwent heat treatment at 500 °C for 4 hours for oxidation, followed by being heated to 800 °C and held at 800 °C for 12 hours for calcination, the temperature ramping rate being 5 °C/min.

### Characterization

The X-ray powder diffraction (XRD) of the formed NMC 811 in FIG. 2-1 confirms the formation of the layered structure. The scanning electron microscopy (SEM) images of the formed NMC 811 (LiNi_{0.82}Mn_{0.06}Co_{0.12}O₂) shown in FIG. 2-2 demonstrate the aggregates of the structures with primary particle size of around 1-2 μm.

### Example 1

Solid-State Synthesis and Characterization of LiNi_{0.82}Mn_{0.06}Co_{0.12}O₂ (NMC 811) with Li₂O₂ in an Oxygen Atmosphere

### Synthesis

5 grams of the oxide precursor from Comparative Example 1 was mixed and grinded with 2 grams of Li₂O₂ (Albemarle Corporation) at a 1.30 Li to TM molar ratio using a mortar and pestle for 10 minutes in the Argon-filled glovebox. The mixture was heated in a tube furnace with constant oxygen flow at 900 °C for 10 hours. The ramping rate and cooling rate were set as 10 °C/min.

### Characterization

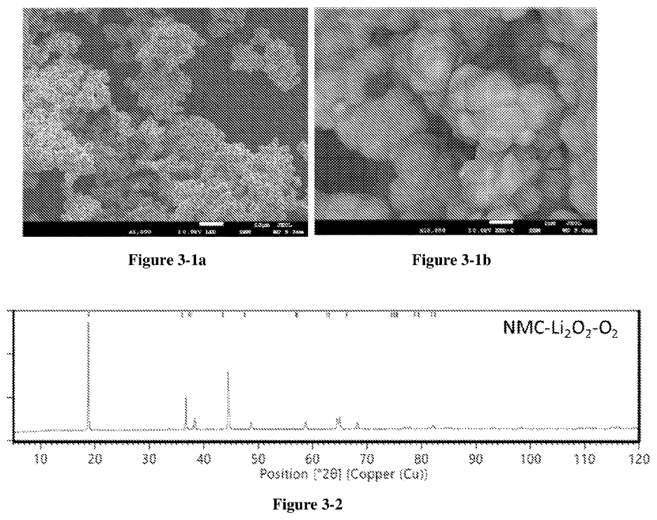

FIGS. 3-1a and 3-1b show the SEM images of the formed NMC 811 from Li₂O₂. No significant difference in the surface and morphologies was found as compared to NMC 811 in comparative example 1 (FIGS. 1-1a and 1-1b). Comparison of NMC 811 XRD of the formed NMC 811 in comparative example 1 (FIGS. 1-2) and comparative example 2 (FIG. 2-2) indicates that NMC synthesized from Li₂O₂ has the same layered structure as that synthesized from Li₂O and LiOH·H₂O. Therefore, the results indicate the feasibility of switching the lithium precursor from Li₂O or LiOH·H₂O to Li₂O₂.

### Example 2

Solid-State Synthesis and Characterization of LiNi_{0.82}Mn_{0.06}Co_{0.12}O₂ (NMC 811) with Li₂O₂ in an Argon Atmosphere

### Synthesis

15 hours of pre-oxidation was carried out at 900 °C to convert the NMC 811 hydroxide precursor to the oxide precursor. 5 grams of the oxide precursor was grinded with 2 grams of Li₂O₂ at a 1.3 Li to TM molar ratio for 10 minutes with a mortar and pestle in the Argon-filled glovebox. The mixtures were calcinated at 900 °C for 10 hours under a constant argon flow. The ramping rate and cooling rate were set as 10 °C/min.

### Characterization

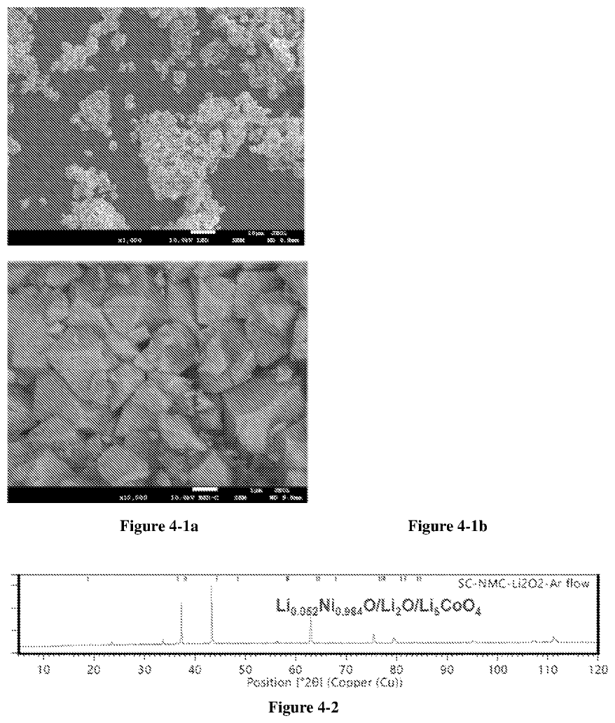

The overall and enlarged SEM images of the final particles are shown in FIGS. 4-1a and 4-1b, respectively, and FIG. 4-2 shows a comparison of O₂ atmosphere (A) synthesized NMC 811 with the argon atmosphere (B, C) synthesized materials. Typically, NMC 811 synthesized in oxygen flow shows a round shape with layered signatures. The product made in an Ar flow shows a different surface morphology (FIGS. 4-1a and 4-1b) and lack of signature 003/104 peak (FIG. 4-2). Further XRD refinement also proves that the final product made in Ar is a mixture of LNO/Li₂O/LCO.

### Example 3

Solid-State Synthesis and Characterization of LiNi_{0.82}Mn_{0.06}Co_{0.12}O₂ (NMC 811) with Li₂O₂ in Ar Atmosphere without Gas Flow

### Synthesis

The pre-oxidation was conducted in oxygen for 15 hours with a constant temperature at 900 °C. 5 grams of oxide precursor was pre-mixed with 2 grams of Li₂O₂ in a 1.3 Li to TM molar ratio using a mortar and pestle in an argon-filled glovebox. The mixtures were calcined at 900 °C for 10 hours in a tube furnace. The tube was purged with Ar gas for 10 minutes, the crucible with the Li₂O₂ and oxide precursor mixture was covered by a cap on top to prevent direct contact with the gas flow, the gas flow was cut off before calcination at 900 °C for 10 hours with 10 °C/min ramping rate.

### Characterization

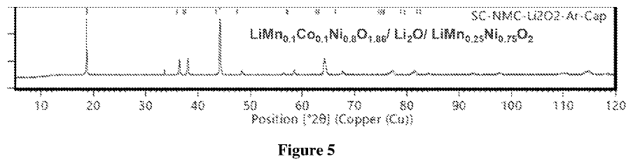

The characterization of the product is highlighted in FIG. 5-1, an XRD of the product confirms the formation of layered structure. Compared with typical layered structure described in Comparative Example 1 and 2, all of the peaks match with those of typical NMC 811 layered structure. With further refinement, the formed product consists of the layered LiMn_{0.1}Co_{0.1}Ni_{0.8}O_{1.86} and Li₂O and LiMn_{0.25}Ni_{0.75}O₂.

### Example 4

Solid-State Synthesis and Characterization of LiNi_{0.82}Mn_{0.06}Co_{0.12}O₂ (NMC 811) with Li₂O₂ in Oxygen Atmosphere without Gas Flow

### Synthesis

The compounds were synthesized from the transition metal-containing precursor Ni_{0.82}Mn_{0.06}Co_{0.12}(OH)₂ and Li₂O₂. 10 grams Ni_{0.82}Mn_{0.06}Co_{0.12}(OH)₂ and the 2.61 grams Li₂O₂ were introduced at 1.05 Li to TM molar ratio into a plastic container for the acoustic mixing at progressively increasing forces of 50 times, 60 times and 70 times gravity, each for 1 min. After mixing, the mixture was transferred to an alumina crucible and placed in a tube furnace. The tube was purged with oxygen for 10 minutes at room temperature and the gas flow stopped before raising the temperature. The Ni_{0.82}Mn_{0.06}Co_{0.12}(OH)₂ and Li₂O₂ mixture underwent heat treatment at 500 °C for 0 or 4 hours for oxidation, followed by being heated to 800 °C and held at 800 °C for 0, 3, 6 or 12 hours for calcination, the temperature ramping rate being 5 °C/min (Table 1).

### Characterization

X-ray powder diffraction (XRD) on a D8 ADVANCE powder diffractometer (Bruker Inc.) using a CuKα anode as the X-ray source (λ=1.54060 Å) confirms that phase pure NMC 811 was formed under these conditions (FIGS. 6, 7-1, 8-1, 9-1 and 10-1). The SEM images of the cross-section of NMC 811 particles are shown in FIGS. 7-2, 8-2, 9-2, and 10-2, respectively.

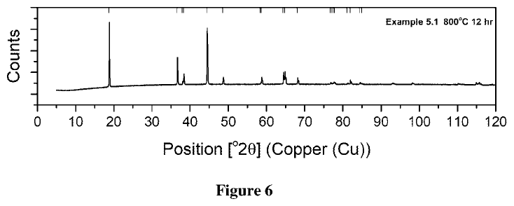

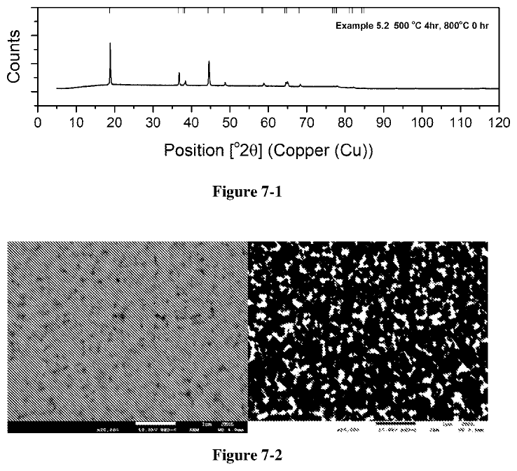

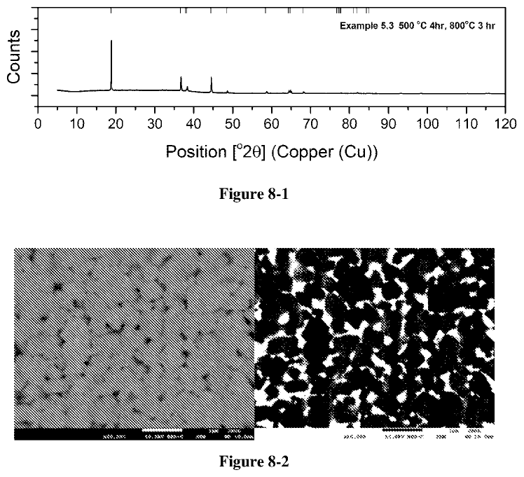

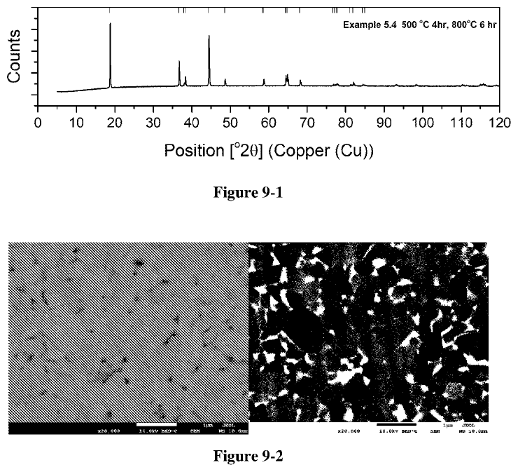

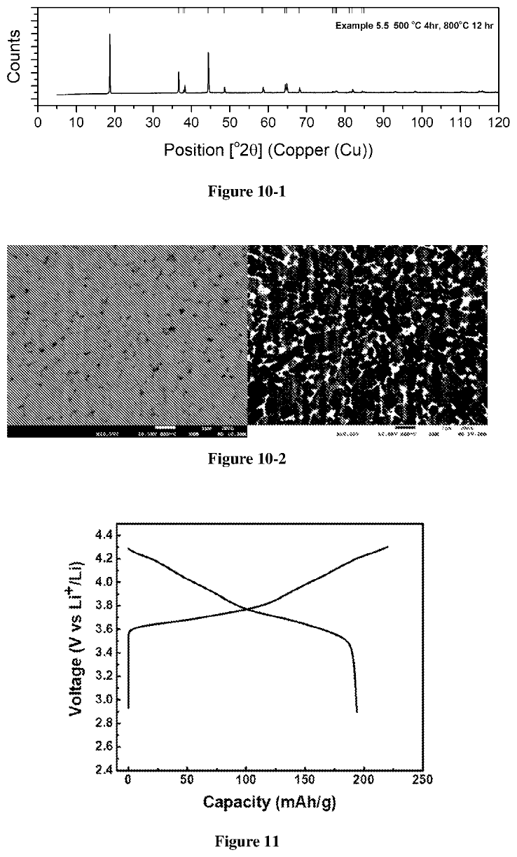

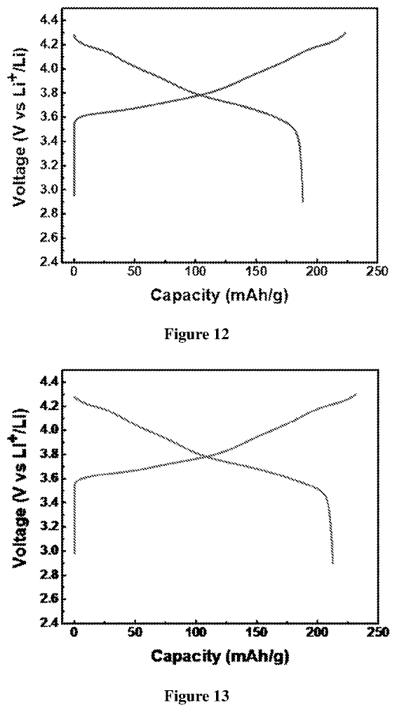

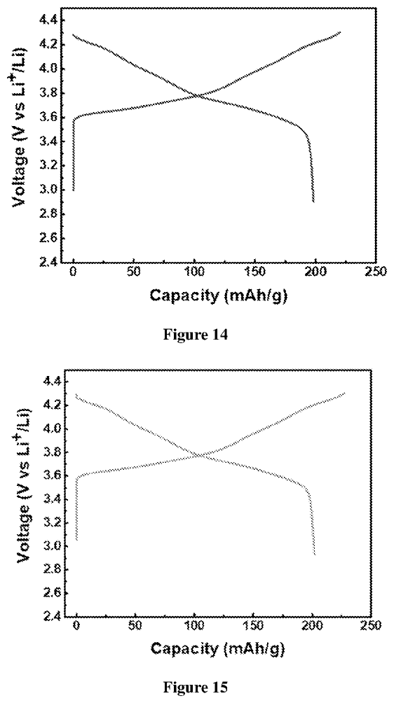

TABLE 1
The heat treatment conditions.

| | | | | | Electro- |
|---|---|---|---|---|---|
| Exam- | 500 °C | 800 °C | | | chemical |
| ple | oxidation | calcination | | SEM | character- |
| No. | (hr) | (hr) | XRD | images | ization |
| 4.1 | 0 | 12 | FIG. 6 | / | FIG. 11 |
| 4.2 | 4 | 0 | FIG. 7-1 | FIG. 7-2 | FIG. 12 |
| 4.3 | 4 | 3 | FIG. 8-1 | FIG. 8-2 | FIG. 13 |
| 4.4 | 4 | 6 | FIG. 9-1 | FIG. 9-2 | FIG. 14 |
| 4.5 | 4 | 12 | FIG. 10-1 | FIG. 10-2 | FIG. 15 |

### Electrochemical Performance

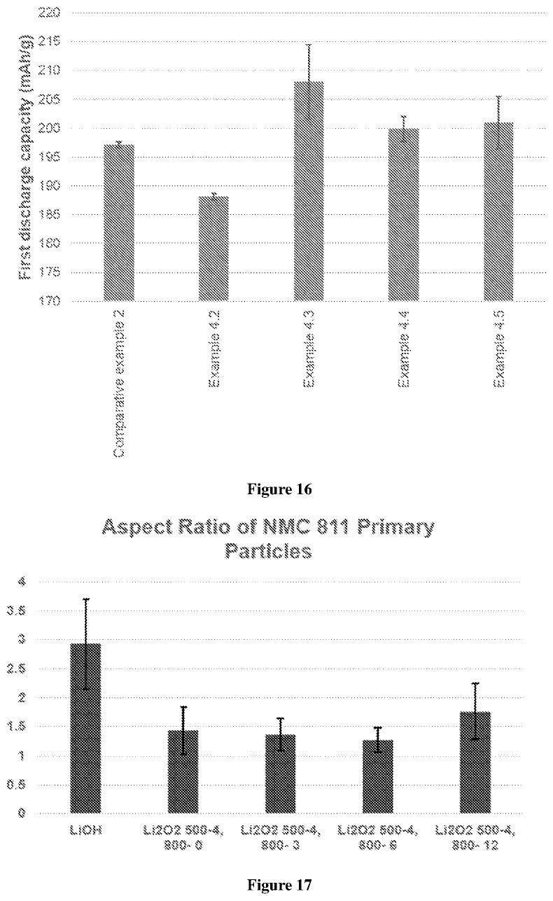

For electrode preparation, 1% of carbon black/carbon nanotube and 2% of the PVDF binder were mixed with the compounds of the disclosure to form the cathode laminates. The thereby obtained laminates were then tested in 2032-coin cells using lithium metal as counter electrodes. The electrolyte consists of 1.2 M of LiPF₆ in ethylene carbonate/diethyl carbonate (vol:vol=3:7) with 5 wt % fluoroethylene carbonate. The cycles were carried out between 2.9V and 4.3V at a rate of C/20. The charge and discharge curves of the compound of disclosure are illustrated from FIGS. 11 to 15, showing the characteristic charge-discharge curves of NMC 811, with varying charge and discharge capacities and Coulombic efficiencies across the different examples in comparison with the NMC 811 synthesized using LiOH·H₂O or LiOH as the lithium precursor (FIG. 16).

### Aspect Ratio of the Primary Particles of the NMC

For purposes of this disclosure and the appended claims, the aspect ratio is that of the primary particles of the given products (Table 2) and is defined as the average length of the major axis of the grains, divided by the average length of the minor axis of the grains, measured from the binary cross-section SEM images of the products described in the comparative example 2 and in example 4 (FIG. 2-1, 7-2, 8-2, 9-2, 10-2). The aspect ratios of the grains were calculated for each example and were tabulated (Table 2 below) and plotted on a bar graph shown at FIG. 17.

TABLE 2
The aspect ratios of the NMC 811 synthesized
under different conditions

| Sample No. | Aspect Ratio |
|---|---|
| Comparative example 2 | 2.93 |
| Example 4.2 | 1.43 |
| Example 4.3 | 1.37 |
| Example 4.4 | 1.27 |
| Example 4.5 | 1.76 |

As can be seen from the data, the aspect ratio for examples in accord with this disclosure are greater than 1 and less than 2. It has also been assessed that, using Li₂O₂ (rather than LiOH) in the process to form NMC 811 results in NMC 811 which is more compositionally homogeneous based on the color differences between primary particles in SEM cross-section images.

### ADDITIONAL ASPECTS OF THE DISCLOSURE

The subject matter is described above with reference to numerous aspects and specific examples. Many variations will suggest themselves to those skilled in the art in light of the above detailed description. All such obvious variations are within the full intended scope of the appended claims. Other aspects of the subject matter disclosed herein can include, but are not limited to, the following (aspects are described as “comprising” but, alternatively, can “consist essentially of”, or “consist of”):

Aspect 1. A process comprising:
calcining a mixed metal oxide composition to form a cathode material,
wherein:
   the mixed metal oxide composition is one formed by mixing (i) a metal-containing precursor and (ii) a lithium precursor comprising lithium peroxide (Li₂O₂), lithium hydroperoxide (LiOOH), lithium peroxide monoperoxohydrate trihydrate (Li₂O₂·H₂)₂·3H₂O) or a mixture of any two or more of the foregoing;
   the metal-containing precursor comprises a compound or a mixture of compounds each having the formula (I) or an oxide counterpart thereof:

qMn(OH)₂·(1−q)NiₐMn_{b}Co_{c}M_{y}X₁₊ₖ (I)
wherein 0≤q≤0.8, c=1−a−b, 0≤a≤1, 0<b≤1, 0≤y≤0.05 and M includes one or more selected from the group consisting of Al, Mg, Ti, Mo, Nb, Zr, Hf, Ta, W, B, P and F; wherein X is selected from the group consisting of OH⁻, CO₃²⁻, NO³⁻, SO₄²⁻, C₂O₄²⁻, C₂H₃O₂⁻, CHO₂⁻, stearate, oleate, tartrate and lactate, and when X is selected from the group consisting of OH⁻, C₃H₃O₂⁻, NO₃⁻, CHO₂⁻, stearate, oleate and lactate, −0.025≤k≤0.25, but when X is otherwise, 0.975≤k≤1.25; and the cathode material so formed comprises a compound having the formula (II):

qLi₂MnO₃·(1−q)LiNiₐMn_{b}Co_{c}M_{y}O_{2+z} (II)
wherein 0≤q≤0.8, c=1−a−b, 0≤a≤1, 0<b≤1, 0≤y≤0.05, −0.025≤z≤0.125, and M is selected from the group consisting of Al, Mg, Ti, Mo, Nb, Zr, Hf, Ta, W, B, P, F and a combination of any two or more of the foregoing.

Aspect 2. The process according to Aspect 1, wherein in the mixing step the moles of Li are equal to or greater than the total aggregate moles of Ni, Mn and Co.

Aspect 3. The process as in any one of Aspects 1-2, wherein the mixing step is conducted under an atmosphere which contains less than 3% by weight of moisture to form mixed metal oxide composition.

Aspect 4. The process as in any one of Aspects 1-3, wherein the calcinating step is conducted with an external supply of gas which contains amount of oxygen in the range of about 0.1 to about 90 percent oxygen by weight.

Aspect 5. The process as in any one of Aspects 1-3, wherein the calcination step is conducted with an external supply of gas which provides an amount of oxygen so that the molar ratio of oxygen provided from the external supply of gas to mixed metal oxide composition being calcined is no greater than 1:4.

Aspect 6. The process as in any one of Aspects 1-5, wherein the calcinating step is conducted in an atmosphere with a moisture content of 3% or less by weight.

Aspect 7. The process as in any one of Aspects 1-6, wherein the mixing step is conducted at ambient temperature and pressure conditions.

Aspect 8. The process as in any one of Aspects 1-7, wherein the calcining step is conducted:
at a temperature in the range of from 500 °C to 1200 °C; and
for a time in the range of from 1 hour to 24 hours.

Aspect 9. The process as in any one of Aspects 1-8, further comprising dehydrating the metal-containing precursor prior to the mixing step.

Aspect 10. The process as in any one of Aspects 1-9, wherein the mixed metal oxide composition is in the form of a particulate having an average particle diameter of less than 100 microns.

Aspect 11. The process as in any one of Aspects 1-10, wherein the cathode material is in the form of a particulate having an average particle diameter of less than 50 microns.

Aspect 12. The process as in any one of Aspects 1-11, wherein the mixed metal oxide composition is continuously fed into a reactor and the cathode material is continuously at least partially removed from the reactor.

Aspect 13. The process as in Aspect 12, wherein the reactor comprises either a rotary reactor or a roller hearth kiln.

Aspect 14. The process as in any of the foregoing Aspects 1-13, wherein the cathode material so formed has an aspect ratio greater than 1 and less than 2.

Aspect 15. A calcined mixed metal oxide composition suitable for forming a cathode material, which composition comprises a compound having the following formula:

qLi₂MnO₃·(1−q)LiNiₐMn_{b}Co_{c}M_{y}O_{2+z} (II)
wherein 0≤q≤0.8, c=1−a−b, 0≤a≤1, 0<b≤1, 0≤y≤0.05, −0.025≤z≤0.125, and M is selected from the group consisting of Al, Mg, Ti, Mo, Nb, Zr, Hf, Ta, W, B, P, F and a combination of any two or more of the foregoing.

Aspect 16. The composition of Aspect 15, wherein the composition has an aspect ratio greater than 1 and less than 2.

1. A process comprising:
calcining a mixed metal oxide composition to form a cathode material,
wherein:
the mixed metal oxide composition is one formed by mixing (i) a metal-containing precursor and (ii) a lithium precursor comprising lithium peroxide (Li₂O₂), lithium hydroperoxide (LiOOH), lithium peroxide monoperoxohydrate trihydrate (Li₂O₂·H₂O₂·3H₂O) or a mixture of any two or more of the foregoing;
the metal-containing precursor comprises a compound or a mixture of compounds each having the formula (I) or an oxide counterpart thereof:
qMn(OH)₂·(1−q)NiₐMn_{b}Co_{c}M_{y}X₁₊ₖ (I)
wherein 0≤q≤0.8, c=1−a−b, 0≤a≤1, 0<b≤1, 0≤y≤0.05 and M includes one or more selected from the group consisting of Al, Mg, Ti, Mo, Nb, Zr, Hf, Ta, W, B, P and F; wherein X is selected from the group consisting of OH⁻, CO₃²⁻, NO₃⁻, SO₄²⁻, C₂O₄²⁻, C₂H₃O₂⁻, CHO₂⁻, stearate, oleate, tartrate and lactate, and when X is selected from the group consisting of OH⁻, C₃H₃O₂⁻, NO₃⁻, CHO₂⁻, stearate, oleate and lactate, −0.025≤k≤0.25, but when X is otherwise, 0.975≤k≤1.25; and
the cathode material so formed comprises a compound having the formula (II):
qLi₂MnO₃·(1−q)LiNiₐMn_{b}Co_{c}M_{y}O_{2+z} (II)
wherein 0≤q≤0.8, c=1-a-b, 0≤a≤1, 0<b≤1, 0≤y≤0.05, −0.025≤z≤0.125, and M is selected from the group consisting of Al, Mg, Ti, Mo, Nb, Zr, Hf, Ta, W, B, P, F and a combination of any two or more of the foregoing.

2. The process according to claim 1, wherein in the mixing step the moles of Li are equal to or greater than the total aggregate moles of Ni, Mn and Co.

3. The process according to claim 1, wherein the mixing step is conducted under an atmosphere which contains less than 3% by weight of moisture to form mixed metal oxide composition.

4. The process according to claim 1, wherein the calcinating step is conducted with an external supply of gas which contains an amount of oxygen in the range of about 0.1 to about 90% of oxygen by weight.

5. The process according to claim 1, wherein the calcinating step is conducted with an external supply of gas which provides an amount of oxygen so that the molar ratio of oxygen provided from the external supply of gas to mixed metal oxide composition being calcined is no greater than 1:4.

6. The process according to claim 1, wherein the calcinating step is conducted in an atmosphere with a moisture content of 3% or less by weight.

7. The process according to claim 1, wherein the mixing step is conducted at ambient temperature and pressure conditions.

8. The process according to claim 1, wherein
the calcining step is conducted:
at a temperature in the range of from 500 °C to 1200 °C; and
for a time in the range of from 1 hour to 24 hours.

9. The process according to claim 1, further comprising dehydrating the metal-containing precursor prior to the mixing step.

10. The process according to claim 1, wherein the mixed metal oxide composition is in the form of a particulate having an average particle diameter of less than 100 microns.

11. The process according to claim 1, wherein the cathode material is in the form of a particulate having an average particle diameter of less than 50 microns.

12. The process according to claim 1, wherein the mixed metal oxide composition is continuously fed into a reactor and the cathode material is continuously at least partially removed from the reactor.

13. The process as in claim 12, wherein the reactor comprises either a rotary reactor or a roller hearth kiln.

14. The process according to claim 1, wherein the cathode material has an aspect ratio greater than 1 and less than 2.

15. A calcined mixed metal oxide composition suitable for forming a cathode material, which composition comprises a compound having the following formula:
qLi₂MnO₃·(1−q)LiNiₐMn_{b}Co_{c}M_{y}O_{2+z} (II)
wherein 0≤q≤0.8, c=1−a−b, 0≤a≤1, 0<b≤1, 0≤y≤0.05, −0.025≤z≤0.125, and M is selected from the group consisting of Al, Mg, Ti, Mo, Nb, Zr, Hf, Ta, W, B, P, F and a combination of any two or more of the foregoing.

16. The composition as in claim 15, wherein the composition has an aspect ratio greater than 1 and less than 2.
